(19) United States
(12) Patent Application Publication
(10) Pub. No.: US 2008/0259977 A1
(43) Pub. Date: Oct. 23, 2008

(54) Waveguide Structure for Upconversion of Ir Wavelength Laser Radiation

(75) Inventors: Arnd Ritz, Heinsberg (DE); Gero Heusler, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/598,321

(22) PCT Filed: Feb. 24, 2005
(86) PCT No.: PCT/IB2005/050680

§ 371 Date: Jul. 9, 2008

(30) Foreign Application Priority Data
Mar. 4, 2004 (EP) 04100877.2

(51) Int. Cl. H01S 3/10

(52) U.S. Cl. 372/28

(57) ABSTRACT

The invention relates to a waveguide structure for upconversion of IR wavelength laser radiation and is characterized in comprising a) at least one base substrate layer made essentially out of a moisture-stable mechanically- and/or temperature-stable material b) at least one active layer made essentially out of a halide glass, preferably a fluoride glass located on the base substrate layer whereby the material of the at least one base substrate layer has a different composition from the material of the at least one active layer.

The invention relates to waveguide structures, in particular to waveguide structures employed in diode laser pumped waveguide lasers, in particular in upconversion waveguide lasers and their use as light source for replacement of a conventional arc lamp. Waveguide lasers employing a waveguide structure according to the present invention can be used as light source to replace conventional arc lamps such as for projection displays as well as for various lighting applications, e.g. headlight, shop, home, accent, spot or theater lighting.

A laser diode is a semiconductor device that produces coherent radiation in which the waves are all at the same frequency and phase in the visible or infrared (IR) spectrum when current passes through it. Waveguide lasers comprise a laser diode as a pump source and a waveguide structure in which the pump radiation of the diode laser is absorbed and converted to a different wavelength. Laser diodes and waveguide lasers are used in optical fiber systems, compact disc (CD), as pump source for solid state lasers, laser printers, remote-control devices, intrusion detection systems and for material processing like welding or cutting.

Thus diode lasers and in addition upconversion waveguide lasers and waveguide structures are generally known in prior art.

However, there exists a long need to simplify the manufacture process of waveguide structures, especially waveguide lasers, in order to provide a waveguide structure with a low vertical range of manufacture, a small number of components, increased robustness, improved compactness and low costs, in order to provide a light source which has superior performance characteristics.

It is the object of this invention to overcome at least some of the above drawbacks and to provide a waveguide structure, which is easier to produce, more compact and has better performance characteristics.

This object is achieved in a waveguide structure for upconversion of IR wavelength laser radiation comprising

a) at least one base substrate made essentially out of a moisture-stable, mechanically- and/or temperature-stable material

b) at least one active layer made essentially out of a halide glass, preferably a fluoride glass located on the base substrate layer whereby the material of the at least one base substrate layer has a different composition from the material of the at least one active layer.

It has been found by the inventors that a waveguide structure with these features is easier to be produced, has fewer parts, especially fewer parts which require special diligence during the manufacture of the waveguide structure and has superior performance characteristics.

Furthermore it should be noted that both active and/or base layer can be either one single layer made out of one more or less uniform material or may comprise several sublayers and/or zones in which the material composition may change.

The term “active layer” as used in the present descriptions means in particular a layer structure that comprises a material that carries the incoupled IR light and the visible light emitted by the material, e.g. via rare earth metals contained therein, by an upconversion process of photon-absorption and energy transfer followed by emission.

According to a preferred embodiment of the present invention, the efficacy of the waveguide structure is ≧10% and ≦90%, the efficacy being defined as

$$\frac{\begin{matrix}emitted power of usable radiation out \\ of the end \text{-} faces of the waveguide structure\end{matrix}}{I R \text{-} power absorbed in the waveguide structure} * 100$$

and usable radiation being defined as upconverted light in the red, green and/or blue spectral range of the visible spectrum.

Preferably, the efficacy of the waveguide structure is ≧15% and ≦90%, more preferred ≧20% and ≦80%, even more preferred ≧30% and ≦70%, yet more preferred ≧40% and ≦65%, and most preferred ≧50% and ≦60%.

According to a preferred embodiment of the present invention, the thickness of the active layer is ≧0 and ≦5 μm, preferably ≧0.5 and ≦4 μm and most preferred ≧1 and ≦3 μm. It has been found out, that by using an active layer with such a thickness, the efficacy of the waveguide structure as described above can be obtained more easily.

Furthermore, a waveguide structure employing an active layer with a thickness as described has a lower required power density. The required power density is the minimum power density that is needed for the active layer to conduct an upconversion process while acting as a laser. According to a preferred embodiment of the present invention, the active layer is pumped with a power density of ≧0.1-≦50 mW/μm², preferred ≧0.5-≦20 mW/μm² and most preferred ≧1-≦10 mW/μm².

This allows the use of wide ranges of IR-laser sources with the present invention.

Preferably the active layer material is selected out of a group containing:

ZBLAN, consisting essentially of the components ZrF₄, BaF₂, LaF₃, AlF₃ and NaF, doped with one or more rare earth ions from the group Er, Yb, Pr, Tm, Ho, Dy, Eu, Nd or a combination thereof, or mixtures thereof; and/or
one or more of the crystals LiLuF₄, LiYF₄, BaY₂F₈, SrF₂, LaCl₃, KPb₂Cl₅, LaBr₃ doped with one or more rare earth ions from the group Er, Yb, Pr, Tm, Ho, Dy, Eu, Nd or a combination thereof; and/or
one or more of the rare earth doped metal fluorides Ba-Ln-F and Ca-Ln-F, where Ln is one or more rare earth ions from the group Er, Yb, Pr, Tm, Ho, Dy, Eu, Nd or a combination thereof, or mixtures thereof.
   or mixtures thereof.

These materials have preferred characteristics for performing an upconversion process as desired. ZBLAN materials are further described in K. Ohsawa, T. Shibita, Preparation and characterization of ZrF₄-BaF₂-LaF₃-NaF-AlF₃ glass optical fibers, Journal of Lightwave Technology LT-2 (5), 602 (1984).

In case that doped materials are used, preferably the doping level of the active layer material and/or of one or more of the active layer material components is from ≧0.01% to ≦40%, from ≧0.05% to ≦30% and most preferably from ≧0.1% to 20%.

The base substrate according to the present invention is preferably chosen from materials, which show one or more, preferably all of the following features:
only a minor absorption in the used range of wavelengths; preferably is the absorption of usable light over the total length of the waveguide structure ≧0% and ≦50%, preferably ≧5% and ≦40% and most preferred ≧10% and ≦30%
a weakening temperature of 300° C. and ≦300° C., preferably ≧500° C., more preferably ≧700° C., yet more preferably ≧1000° C., and most preferred ≧1200° C., and/or
a weakening temperature difference between the active layer material and the base substrate material of ≧50° C. and ≦2000° C., preferably ≧100° C., more preferably ≧200° C., yet more preferably 2300° C., and most preferred ≧400° C.; and/or
a good surface handling; and/or
a lower refractive index than the active layer material; preferably is the difference between the refractive index of the active layer material and the base substrate ≧0.001 and ≦0.25, preferably ≧0.002 and ≦0.15; and/or more preferably ≧0.005 and ≦0.05.
good chemical resistance, especially moisture stability, which allows a better technical production of the waveguide structure.

According to a preferred embodiment of the present invention, the base substrate layer material is selected out of a group comprising quartz glass, hard glass, MgF₂ and mixtures thereof. These materials fulfil all of the required and preferred features as set out above.

According to a preferred embodiment of the present invention, the active layer is coated on the base substrate layer by hot dip spin coating. The process of Hot dip spin coating is as such known in the art and e.g. described by Favre et al, SPIE Photonics West Conference, Paper 4990-21, San Jose, Calif., 25-31 January, 2003, which is fully incorporated by reference. In short, the process of hot dip spin coating process works by dipping an optionally preheated substrate first into a crucible of a molten material, which is to form the layer on the substrate. As the coated substrate is withdrawn from the bath of the molten layer material, it is accelerated to a spin speed, usually about 2000 rpm, which throws off excess layer material and thins out the layer to the required thickness.

In this regard, the inventors have noted, that a base substrate, which has a weakening temperature of ≧300° C. and ≦2000° C., preferably ≧500° C., more preferably ≧700° C., yet more preferably ≧1000° C., and most preferred ≧1200° C. is most preferred to be used within this technique, since it allows to build up layers with reduced thickness on the base substrate. This for the reason that the layer, which is first build by dipping the base substrate in the molten layer material, is reduced to the wanted thickness by simply spinning the base substrate. This requires the molten layer material to remain in a somewhat liquid state during the spinning, because otherwise a further reduction of the layer cannot be achieved. Therefore the temperature of the base substrate when dipped into the molten layer material should be as high as possible as allowed by the temperature stability and viscosity of the layer material in order to enlarge the “time window” for thinning the layer on the base substrate. Of course the base substrate itself should not be affected by the hot dip spinning process. The inventors have found out, that for this reason, base substrates with weakening temperatures as set above are most preferred.

According to a preferred embodiment of the present invention, the length of the active layer is ≧100 μm and ≦100,000 μm, preferably ≧200 μm, more preferably ≧500 μm and most preferably ≧1000 μm and ≦50,000 μm; and/or a width of the active layer is ≧1 μm and ≦200 μm, preferably ≧2 μm and ≦100 μm, and most preferred ≧10 μm and ≦50 μm. Preferably the width of the active layer is ≧0.1 μm to ≦100 μm, preferably ≧1 μm to ≦50 μm larger than that of the laser source.

However, the length and width of the active layer should be chosen in that way, that:
the IR radiation, which is impinged on the waveguide structure, is absorbed to an amount of ≧50%, preferably ≧60% and most preferred ≧80%; and
dimensions of the waveguide structure match and/or are adapted to the IR radiation source.

According to a preferred embodiment of the present invention, the waveguide structure furthermore comprises a sealing layer located on the active layer in such a way, that the active layer is between the base substrate layer and the sealing layer, the sealing layer material being preferably selected out of a group comprising SiO₂, higher index of refraction materials, preferably Al₂O₃, and/or Si₃N₄, polymers, spin on glass or mixtures thereof, either alone or in combination with an optical isolation layer, preferably from undoped ZBLAN.

Since the preferred materials for the active layer are moisture-sensitive, it is preferred that the active layer is protected on both sides, first by the base substrate, which is moisture-stable and second by the sealing layer. By this design, a mass production of the waveguide structure can easier be obtained and the waveguide structure itself is more robust.

Another object of the present invention relates to a lighting unit comprising at least one of the waveguide structures of the present invention being designed for the usage in one of the following applications:
shop lighting,
home lighting,
accent lighting,
spot lighting,
theater lighting,
automotive headlighting,
fiber-optics applications, and
projection systems.

### Measurement Methods

Measurement methods for the terms used in this invention are known in the art; however, any skilled person may obtain them from one or more of the following documents, which are fully incorporated by reference
J. F. Massicott et al., Electronics Letters, Vol. 29 (24), pp. 2119-2120 (1993),
T. Sandrock et al., Optics Letters, Vol. 24 (18), pp. 1284-1286 (1999)≦
<<Rare Earth Doped Fiber Lasers and Amplifiers>>, Ed. Michel J. F. Digonnet, Verlag-Marcel Dekkei; Inc., especially p. 204 following
A. C. Tropper et al., Journal of the Optical Society of America B, Vol. 11 (5), pp. 886-893 and further references cited therein.

1. A waveguide structure for upconversion of IR wavelength laser radiation comprising a) at least one base substrate layer made essentially out of a moisture-stable mechanically- and/or temperature-stable material; b) at least one active layer made essentially out of a halide glass, preferably a fluoride glass located on the base substrate layer whereby the material of the at least one base substrate layer has a different composition from the material of the at least one active layer

2. A waveguide structure according to claim 1, whereby the efficacy of the waveguide structure is ≧10% and ≦90%, the efficacy being defined as
$$\frac{\begin{matrix}radiated and \text{/} or emitted power of usable \\ radiation out of the waveguide structure\end{matrix}}{I R \text{-} power absorbed in the waveguide structure} * 100$$
and usable radiation being defined as upconverted light in red, green and/or blue

3. A waveguide structure according to claim 1 or 2, whereby the thickness of the active layer is 20 and ≦5 μm.

4. A waveguide structure according to claim 1 or 3, whereby the active layer material is selected out of a group containing: —ZBLAN, consisting essentially of the components ZrF₄, BaF₂, LaF₃, AlF₃ and NaF, doped with one or more rare earth ions from the group Er, Yb, Pr, Tm, Ho, Dy, Eu, Nd or a combination thereof, —one or more of the crystals LiLuF₄, LiYF₄, BaY₂F₈, SrF₂, LaCl₃, KPb₂Cl₅, LaBr₃ doped with one or more rare earth ions from the group Er, Yb, Pr, Tm, Ho, Dy, Eu, Nd or a combination thereof, —one or more of the rare earth doped metal fluorides Ba-Ln-F and Ca-Ln-F, where Ln is one or more rare earth ions from the group Er, Yb, Pr, Tm, Ho, Dy, Eu, Nd or a combination thereof, or mixtures thereof. or mixtures thereof.

5. A waveguide structure according to any of the claims 1 to 3, whereby the base substrate layer material has a weakening temperature of ≧300° C. and ≦2000° C. and/or has a lower refractive index than the active layer material.

6. A waveguide structure according to claims 1 to 5, whereby the base substrate layer material is selected out of a group comprising quartz glass, hard glass, MgF₂ and mixtures thereof.

7. A waveguide structure according to claims 1 to 6, whereby the active layer is coated on the base substrate layer by hot dip spin coating.

8. A waveguide structure according to claims 1 to 7, whereby
a length of the active layer is ≧100 μm and ≦100,000 μm, preferably ≧200 μm, more preferably ≧500 μm and most preferably ≧1000 μm and ≦50,000 μm; and/or
a width of the active layer is ≧1 μm and ≦200 μm

9. A waveguide structure according to claims 1 to 8, furthermore comprising a sealing layer located on the active layer in such a way, that the active layer is between the base substrate layer and the sealing layer, the sealing layer material being preferably selected out of a group comprising SiO₂, higher index of refraction materials, preferably Al₂O₃ and/or Si₃N₄, polymers, spin on glass or mixtures thereof, either alone or in combination with an optical isolation layer, preferably from undoped ZBLAN.

10. A lighting unit comprising at least one of the waveguide structures according to one of the claims 1 to 9, being designed for the usage in one of the following applications: —shop lighting, —home lighting, —accent lighting, —spot lighting, —theater lighting, —automotive headlighting, —fiber-optics applications, and projection systems.
